(19) United States
(12) Patent Application Publication
(10) Pub. No.: US 2020/0197246 A1
(43) Pub. Date: Jun. 25, 2020

(54) WALKING ASSISTANCE APPARATUS FOR THE OLD AND THE WEAK

(71) Applicant: INDUSTRY ACADEMIC COOPERATION FOUNDATION JEONNAM STATE UNIVERSITY, Jeollanam-do (KR)

(72) Inventor: Jong Myung KIM, Gwangju (KR)

(21) Appl. No.: 15/752,773

(22) PCT Filed: Feb. 5, 2018
(86) PCT No.: PCT/KR2018/001504

§ 371 Date: Feb. 14, 2018

(30) Foreign Application Priority Data
Dec. 26, 2017 (KR) 10-2017-0178987

(51) Int. Cl. A61G 5/14

(52) U.S. Cl. CPC A61G 5/14; A61H 3/04

(57) ABSTRACT

A walking assistance apparatus for the old and the weak includes a chair including a seat panel having a front side and a rear side, the front side coupled with a hinge shaft to rotate the seat panel in a direction in which the rear side of the seat panel is lifted, and a seat panel lifting module for pushing up and lifting the rear of the seat panel of the chair. The old and the weak can easily stand up from the chair by lifting the chair upward.

### TECHNICAL FIELD

The present invention relates to a Walking assistance apparatus for the old and the weak, more particularly to a Walking assistance apparatus for the old and the weak so that the old and the weak can easily stand up from the chair by lifting the chair upward.

### BACKGROUND ART

Generally, elderly people who have a lot of old age or physical disabilities who are uncomfortable to move are difficult to walk by themselves, so they often move using assistive devices to assist walking.

As such a walking stick is used by the elderly and the handicapped as a typical walking aids. But it is difficult for the elderly or the handicapped to use the walking stick because the strength of the user's arms and legs should be supported.

Therefore, recently walking assistance apparatuses are used so that the patient, the elderly or the disabled having leg or body discomfort can move and support the body when walking lightly or moving to the other place.

Korean Patent Publication No. 10-2009-0098369 (Walking assistant apparatus for the old and the weak), Korean Patent Publication No. 10-2014-0075480 (Walk Assist Device for the Elderly and the Infirm), Korean Patent Registration No. 10-1654843 (Walking Aids for Elderly Disabled People with Forearm Support) disclose walking assistance apparatuses with a wheel at a lower portion of the main body which can be operated while the elderly person grasps the handle with the hand and pushes or pulls it.

By referring to FIG. 1 which shows Walking assistance apparatus for the old and the weak according to the present invention, in the conventional Walking assistance apparatus 1 for the old and the weak as described above, a chair 20, on which elderly people can usually sit, is provided in main body 10 of an apparatus.

However, when the elderly person sits on the chair 20 provided in the walking assistance apparatus for the old and the weak 1, a lot of power is consumed for the elderly person to stand up, and in some cases, the elderly person may be injured while sitting back again.

### DISCLOSURE

### Technical Problem

The present invention has been invented recognizing the above-described points, the object of the present invention is to provide a walking assistance apparatus for the old and the weak that enable the elderly to stand up easily from the chair by lifting the chair upward.

### Technical Solution

To solve the above problem, a walking assistance apparatus for the old and the weak equipped with a chair according to the present invention is characterized in that the front side of the seat panel of the chair is coupled with the hinge shaft so that the seat panel is rotated in a direction in which the rear side of the seat panel is lifted; and is characterized by comprising a seat panel lifting module for pushing up and lifting the rear of the seat panel of the chair.

Further, a walking assistance apparatus for the old and the weak according to the present invention is characterized in that the seat panel lifting module includes a compression spring, one end of which is hinged to a lower structure of the chair, and the other end of which is hinged to the bottom of the seat panel of the chair; and the compression spring is stretched to lift the seat panel of the chair.

Further, a walking assistance apparatus for the old and the weak according to the present invention is characterized in that the seat panel lifting module further includes a locking means with which the seat panel is engaged in a state in which the compression spring is compressed, and the seat panel is lowered.

Further, a walking assistance apparatus for the old and the weak according to the present invention is characterized in that the locking means include a joining rod attached to the bottom of the seat panel of the chair; a locker part located below the seat panel, to which the joining rod enters and is coupled by the descent of the seat panel; and a releasing part releasing the engagement between the locker part and the joining rod so that the joining rod is separated from the locker part.

Further, a walking assistance apparatus for the old and the weak according to the present invention is characterized in that a support plate is attached to the bottom of the seat panel of the chair, one end of the compression spring is connected to the bottom surface of the support plate; and the joining rod is attached to the bottom surface of the support plate so as to be placed in front and back direction on the bottom surface of the support plate.

### Advantageous Effects

By the above described configuration, a walking assistance apparatus for the old and the weak according to the present has the advantage that the elderly can easily stand up from the chair by lifting the chair upwards.

### BRIEF DESCRIPTION OF DRAWINGS

FIG. 1 is a side view illustrating the walking assistance apparatus for the old according to an embodiment of the present invention;

FIG. 2 is an exploded perspective view showing a seat panel lifting module of the walking assistance apparatus for the old according to an embodiment of the present invention;

FIG. 3 is a side view showing a state in which the seat panel lifting module of the walking assistance apparatus for the old according to an embodiment of the present invention;

FIG. 4 is a side view conceptually showing an operation of raising a chair so that the seat panel lifting module assists the elderly standing up from the chair of the walking assistance apparatus for the old according to an embodiment of the present invention;

FIG. 5 is a side view showing a locking means of the seat panel lifting module of the walking assistance apparatus for the old according to an embodiment of the present invention;

### EXPLANATION OF SYMBOLS

1 a walking assistance apparatus for the old and the weak

10 main body of the assistance apparatus

11 wheel

12 handle

20 chair

21 seat panel

22 back

23 arm rest

30 storage basket

40 seat panel lifting module

41 support plate

42 compression spring

43 locking means

431 joining rod

432 locker part

432a fixed jaw

432b movable jaw

433 releasing part

44 support frame

### Mode for Invention

Hereinafter, the walking assistance apparatus for the old and the weak according to the present will be described in more detail with reference to the embodiments shown in the drawings.

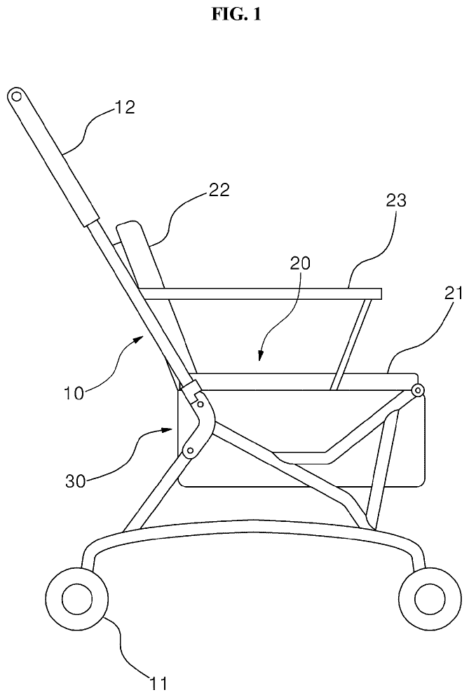

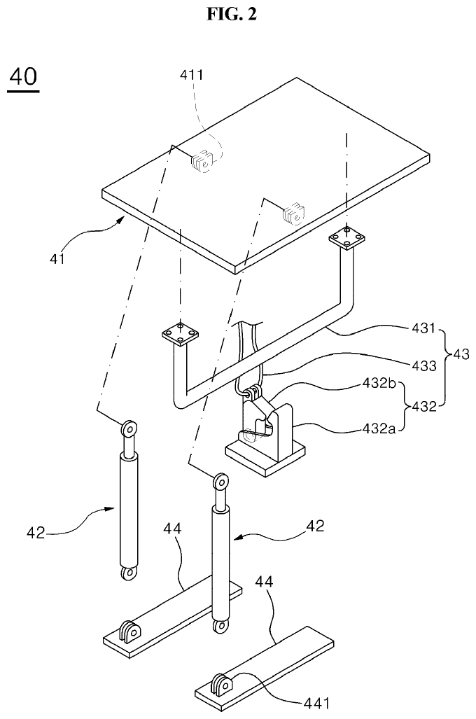

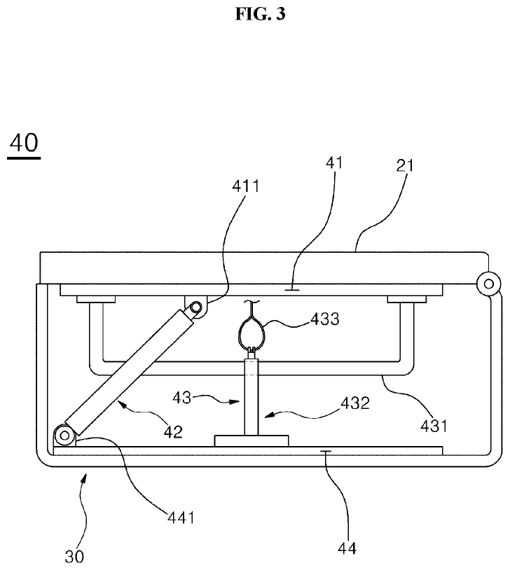

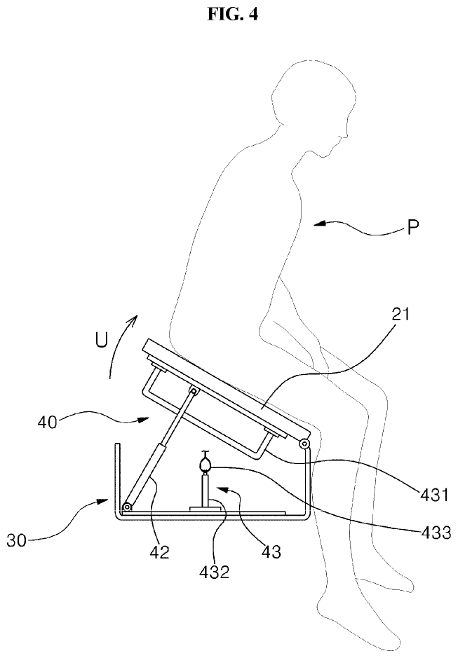

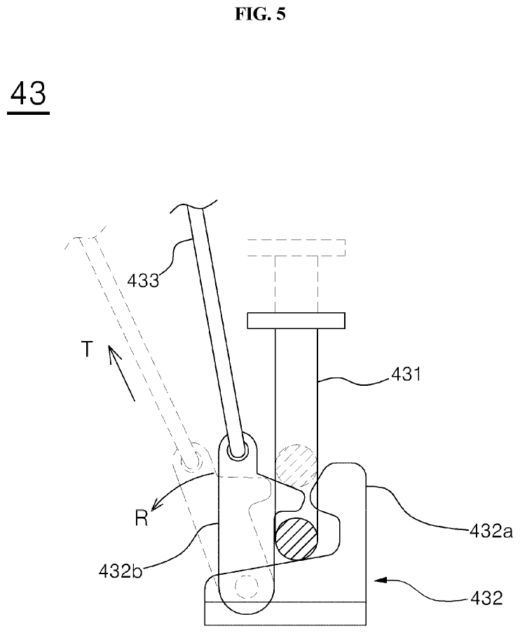

FIG. 1 is a side view illustrating the walking assistance apparatus for the old according to an embodiment of the present invention, FIG. 2 is an exploded perspective view showing a seat panel lifting module of the walking assistance apparatus for the old according to an embodiment of the present invention, FIG. 3 is a side view showing a state in which the seat panel lifting module of the walking assistance apparatus for the old according to an embodiment of the present invention, FIG. 4 is a side view conceptually showing an operation of raising a chair so that the seat panel lifting module assists the elderly standing up from the chair of the walking assistance apparatus for the old according to an embodiment of the present invention, and FIG. 5 is a side view showing a locking means of the seat panel lifting module of the walking assistance apparatus for the old according to an embodiment of the present invention.

The walking assistance apparatus 1 for the old and the weak according to the present is configured to assist the elderly person P sitting in the chair 20 to stand up by raising the seat panel 21 of the chair 20.

Referring to the drawings, the walking assistance apparatus 1 for the old and the weak according to the present is composed of a main body 10 of the assistance apparatus, a chair 20 and a storage basket 30 like a normal walking assistance apparatus.

That is, in the walking assistance apparatus 1 for the old and the weak according to the present, a wheel 11 is provided at the lower portion of a main body 10 and a handle 12 which the elderly person P hold by hand to push is provided on one side of the upper portion of a main body 10.

The chair 20 is formed in front of the main body 10 of the assistance apparatus so that the elderly person P can sit thereon. And the chair 20 includes a seat panel 21 laid flat on the main body 10, a back 22 erected upward from the rear of the seat panel 21 to support the back of the elderly person P, and an arm rest 23 protruding upward from both sides of the seat panel 21 and becoming integral with the main body 10.

Normally, the chair 20 has a structure similar to a general chair. But in the present invention, the front portion of seat panel 20 is hinged so that the rear portion of the seat panel 21 of the chair 20 is raised. That is, front side of the seat panel 21 of the chair 20 is coupled to the main body 10 with a hinge shaft so that the seat panel 21 is rotated in a direction in which the rear side of the seat panel 21 is lifted.

The storage basket 30 is provided under the seat panel 21 of the chair 20 and normally, the seat panel 21 functions as a cover for covering the upper entrance of the storage basket 30. Normally, the storage baskets 30 contain necessary articles, but in the present invention a seat panel lifting module 40 for lifting the seat panel 21 of the chair 20 is accommodated in the storage basket 30 and mounted on the lower portion of the seat panel 21. That is, the storage basket 30 forms a structure in which the seat panel lifting module 40 is housed and mounted.

The seat panel lifting module 40 is configured to lift the rear side of the seat panel 21 of the chair 20 upward to push upwardly the elderly person P who wants to get up from the seat panel 21.

Referring to the drawings, the seat panel lifting module 40 includes a support plate 41, a compression spring 42, a locking means 43, and a support frame 44.

The support plate 41 is a plate-like member which is attached to the bottom surface of the seat panel 21 of the chair (20), while supporting the seat 21, the compression spring 42 and the coupling rod 431 of the locking means 43 are coupled to. At a rear position of the support plate 41, a hinge bracket 411 for hinge-connecting the compression spring 42 to both sides is provided to protrude downward.

The compression spring 42 is compressed and stretched to apply a force to lift the seat panel 21 of the chair 20 to the rear portion of the seat panel 21. In the figure, a cylinder-shaped gas spring using air compression is shown as the compression spring 42. Referring to the drawing, one end, i.e., the lower end, of the gas spring, which is the compression spring 42, is hinged to a support frame 44 fixed to the bottom of the storage basket 30, which is a lower structure of the chair 20, and the other end, i.e., the upper end, is hingedly connected to a support plate 41 attached to a seat panel bottom of the chair.

When the elderly person P sits on the chair 20 and presses the seat panel 21 downward, the compression spring 42 is compressed and the seat panel 21 is lowered. Then, when the elderly person P stands up from the chair 20, the compression spring 42 pushes the elderly person P to be raised by pushing up the rear portion of the seat panel 21 upward.

Meanwhile, when the elderly person P sits on the chair 20 and pushes the seat panel 21 downward, the compression spring 42 is compressed and the seat panel 21 is lowered. It is preferable that the seat panel 21 is lowered so that the elderly person P can sit comfortably at this time. For this purpose, a locking means 43 for holding the lowered seat panel 21 is provided.

That is, the locking means 43 is configured such that the seat panel 21 is not elevated in a state where the compression spring 42 is compressed and the seat plate 21 is lowered. Referring to the drawings, the locking means 43 includes a joining rod 431, a locker part 432, and a release part 433.

The joining bar 431 is attached to the bottom of the seat panel 21 of the chair 20 and is coupled to the locker part 432 fixed to the bottom of the storage basket 30. Referring to the drawings, the joining rod 431 is attached to the bottom surface of the support plate so that the joining rod 431 is placed on the bottom surface of the support plate 41 attached to the bottom surface of the seat panel 21. The coupling rod 431 enters the locker part 432 fixed to the bottom of the storage basket 30 by the descent of the seat panel 21 and is coupled to the locker part 432, thereby the seat panel 21 is not raised when the locker part 432 and the joining rod 431 are not separated from each other.

The locker part 432, which is positioned below the seat panel 21 (I.e., the bottom of the storage basket 30), is configured such that the joining rod 431 is not detached when the joining rod 431 enters by the lowering of the seat plate 21,

Referring to the drawings, the locker part 431 includes a fixed jaw 432a fixed to the bottom of the storage basket 30, a movable jaw 432b which is engaged with the fixed jaw 432a or separated from the fixed jaw 432a while being relatively rotated with respect to the fixed jaw 432a, and a bias spring (not shown in the drawings) for biasing the movable jaw 432b in a direction in which the movable jaw 432b engages with the fixed jaw 432a. The movable jaw 432b is kept biased by the bias spring in a direction to engage with the fixed jaw 432a, The movable jaw 432b is temporarily opened in a direction separating from the fixed jaw 432a when the joining rod 431 enters a gap between the fixed jaw 432a and the movable jaw 432b due to the descent of the seat panel 21, and when the joining rod 431 is fully enters a gap, the joining rod 431 is engaged with the fixed jaw 432a the movable jaw 432b so that the joining rod 431 is not detached, while the movable jaw 432b is engaged with the fixed jaw 432a by the bias spring. As described above, when the movable jaw 432b is biased by the biasing spring, the joining rod 431 is engaged with the fixed jaw 432a and the movable jaw 432b, and, accordingly, the seat panel 21 is kept in a lowered state without being lifted even in a state in which the compression spring 42 is under the force of lifting upwards.

As described above, in a state in which the joining rod 431 is engaged with the fixing jaw 432a and the movable jaw 432b, when the movable jaw 432b is rotated in the direction R in which the movable jaw 432b is separated from the fixed jaw 432a by using the releasing part 433 in order for the elderly person P to stand up, the joining rod 431 is separated from the locker part 431, as a result, the seat panel 21 is rotated so that the rear part thereof is raised by the extension of the compression spring 42.

The release part 433 is configured to release the engagement between the locker part 432 and the joining rod 431 so that the joining rod 431 is separated from the locker part 432. Referring to the drawings, the release part 433 is constituted by a wire is connected at one end to the movable jaw 432b and at the other end extended to be hand-held by the elderly person P. And when the elderly person P pulls the wire as the release part 433 and the movable jaw 432b is rotated in the direction R in which the movable jaw 432b is separated from the fixed jaw 432a, the joining rod 431 is separated from the locker part 431.

The support frame 44 is configured to be hinged to the lower end of the compression spring 42, and fixedly placed on the bottom of the storage basket 30 long in the forward and backward direction. A hinge bracket 441 for hinge-connecting the lower end of the compression spring 42 is formed at a rear portion of the support frame 44.

A walking assistance apparatus for the old and the weak described in the drawings and above is only one embodiment for practicing the present invention and should not be construed as limiting the technical idea of the present invention. The scope of protection of the present invention is determined only by the matters described in the following claims. As long as the embodiments improved or modified without departing from the point of the present invention are self-evident to those skilled in the art, they will belong to the scope of protection of the present invention.

### Industrial Applicability

The walking assistance apparatus for the old and the weak having the above-described configuration, which allows the elderly person to stand up easily from the chair by lifting the chair upward, is very useful inventions in industry.

1. A walking assistance apparatus, comprising:
a chair comprising a seat panel having a front side and a rear side, the front side coupled with a hinge shaft to rotate the seat panel in a direction in which the rear side of the seat panel is lifted; and
a seat panel lifting module for pushing up and lifting the rear of the seat panel of the chair.

2. A walking assistance apparatus of claim 1, wherein the seat panel lifting module includes a compression spring, one end of which is hinged to a lower structure of the chair, and the other end of which is hinged to a bottom of the seat panel of the chair; and
the compression spring is stretched to lift the seat panel of the chair.

3. A waking assistance apparatus of claim 1, wherein the seat panel lifting module includes a compression spring and a locking device with which the seat panel is engaged in a state in which the compression spring is compressed, and the seat panel is lowered.

4. A walking assistance apparatus of claim 3, wherein the locking device includes a joining rod attached to a bottom of the seat panel of the chair;
a locker part located below the seat panel, to which the joining rod enters and is coupled by a descent of the seat panel; and
a releasing part releasing an engagement between the locker part and the joining rod so that the joining rod is separated from the locker part.

5. A walking assistance apparatus of claim 4, further comprising a support plate attached to the bottom of the seat panel of the chair,
wherein one end of the compression spring is connected to a bottom surface of the support plate; and
the joining rod is attached to the bottom surface of the support plate so as to be placed in front and back direction on the bottom surface of the support plate.
